(19) United States
(12) Patent Application Publication
(10) Pub. No.: US 2015/0085184 A1
(43) Pub. Date: Mar. 26, 2015

(54) SMARTPHONE AND TABLET HAVING A SIDE-PANEL CAMERA

(71) Applicants: JOEL VIDAL, TENAFLY, NJ (US); YAEL VIDAL, TENAFLY, NJ (US)

(72) Inventors: JOEL VIDAL, TENAFLY, NJ (US); YAEL VIDAL, TENAFLY, NJ (US)

(21) Appl. No.: 14/036,842

(22) Filed: Sep. 25, 2013

(51) Int. Cl. H04N 5/225

(52) U.S. Cl. CPC H04N 5/2252
USPC 348/376

(57) ABSTRACT

The present invention includes a smartphone or a tablet having a camera, or having multiple cameras, and particularly having a side-camera or a top-side camera. A smartphone or a tablet includes: a wireless transceiver to send and receive wireless communication signals; a processor to execute code; a front-side panel comprising a touch-screen; a back-side panel, located opposite to and generally parallel to the front-side panel, the back-side panel comprising a back-side camera; a side panel, being generally perpendicular to the front-side panel and being generally perpendicular to the back-side panel, the side panel comprising a side camera.

### FIELD

Some embodiments are related to the field of electronic devices.

### BACKGROUND

Many people use cellular phones in order to make and receive phone calls. For example, a user may utilize a cellular phone in order to talk with friends, stay in touch with family members, and transact business with co-workers and business associates while being away from the user's home or office.

Many users utilize a smartphone, which may include features of a cellular phone as well as features of a Personal Digital Assistant (PDA). For example, a smartphone may be used for placing and receiving phone calls, as well as for browsing the Internet, taking photographs by utilizing an integrated camera, playing games, sending and receiving electronic mail (email), maintaining a calendar or schedule, or the like.

Many users utilize a tablet, which may be a mobile computer having a touch-screen that the user may operate by using finger gestures or stylus gestures, rather than by using a physical keyboard or a computer mouse. Tablets are often used for casual computing tasks, particularly for browsing the Internet, reading online content, sending and receiving email messages, and playing games.

### SUMMARY

Some embodiments may include an electronic device, for example, a smartphone or a tablet or a mini-tablet or a “phablet” (phone-tablet), having a camera (or an aperture or orifice for an imaging sensor or for an imager) embedded in or integrated in a side-face which is generally perpendicular to the face having the touch-screen.

Some embodiments may include a smartphone or tablet having a top-side camera; for example, in addition to a front-side camera and/or a back-side camera.

Some embodiments may include a smartphone or tablet having a right-facing camera; for example, in addition to a front-side camera and/or a back-side camera.

Some embodiments may include a smartphone or tablet having a left-facing camera; for example, in addition to a front-side camera and/or a back-side camera.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIGS. 1A-1C are schematic illustrations of multiple views of an electronic device, in accordance with some demonstrative embodiments of the present invention;

FIG. 1D is a schematic illustration of another electronic device, in accordance with some demonstrative embodiments of the present invention;

FIG. 1E is a schematic illustration of yet another electronic device, in accordance with some demonstrative embodiments of the present invention;

FIGS. 2A-2C are schematic illustrations of multiple views of still another electronic device, in accordance with some demonstrative embodiments of the present invention;

FIG. 3 is a flow-chart of a method, in accordance with some demonstrative embodiments of the present invention;

FIGS. 4A-4G are schematic illustrations of multiple views of an electronic device, having a top-panel side-camera located in the central region of the top-panel, in accordance with some demonstrative embodiments of the present invention;

FIGS. 5A-5G are schematic illustrations of multiple views of an electronic device, having a top-panel side-camera located in the leftmost region of the top-panel, in accordance with some demonstrative embodiments of the present invention;

FIGS. 6A-6G are schematic illustrations of multiple views of an electronic device, having a top-panel side-camera located in the rightmost region of the top-panel, in accordance with some demonstrative embodiments of the present invention.

### DETAILED DESCRIPTION OF SOME EMBODIMENTS

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

The term “side-camera” or “side-panel camera” as used herein may include, for example, a camera other than (a) front-side (front-facing) camera, and also other than (b) back-side (back-facing) camera. The term “side-camera” or “side-panel camera” as used herein may include, for example, a non-front non-back camera, or a non-front-facing and non-rear-facing camera; or a camera facing (or aiming) towards a right-side or left-side or top-side or bottom-side relative to the electronic device that the camera is embedded in; or a camera located on, or within, or at, or on top of, or integrated in, or embedded in, a side-panel.

The term “side-panel” as used herein may include, for example, any side other than the front side (which has the screen or the touch-screen) and other than the back side (or the rear side, or the side that is generally opposite to the touch-screen, or the side that is generally parallel to the touch-screen); or a right-side panel, or a left-side panel, or a top-side panel, or a bottom-side panel; or a right-side face, or a left-side face, or a top-side face, or a bottom-side face.

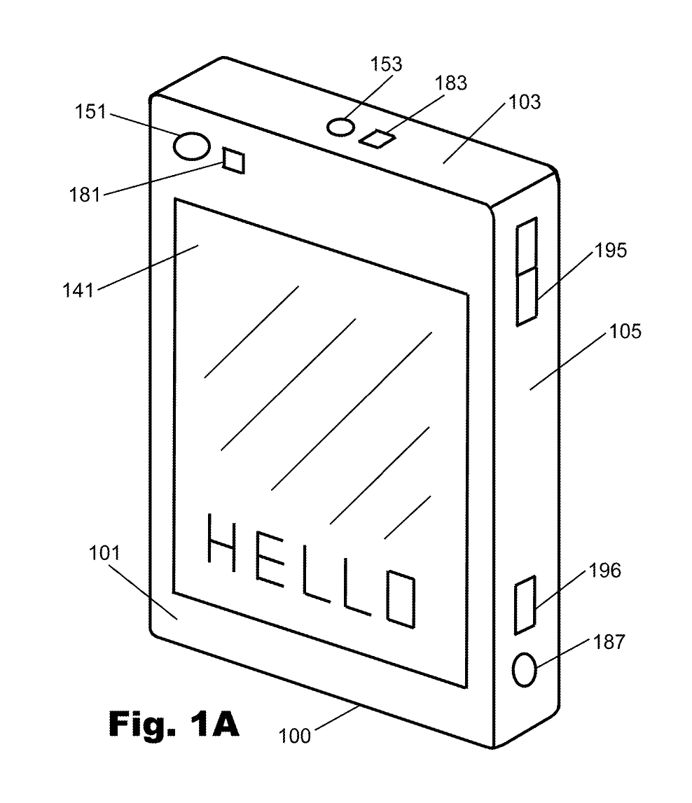

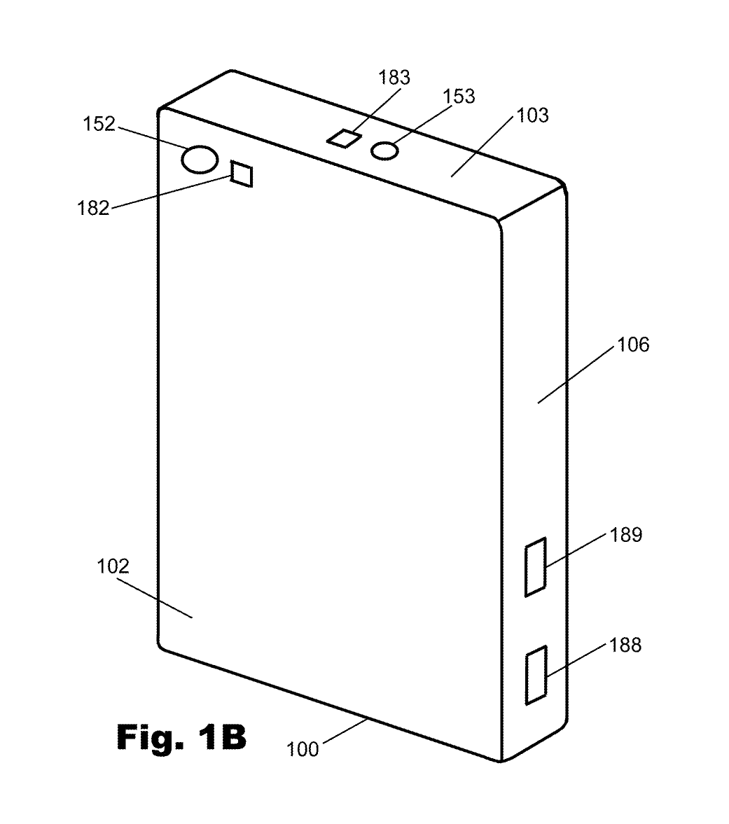

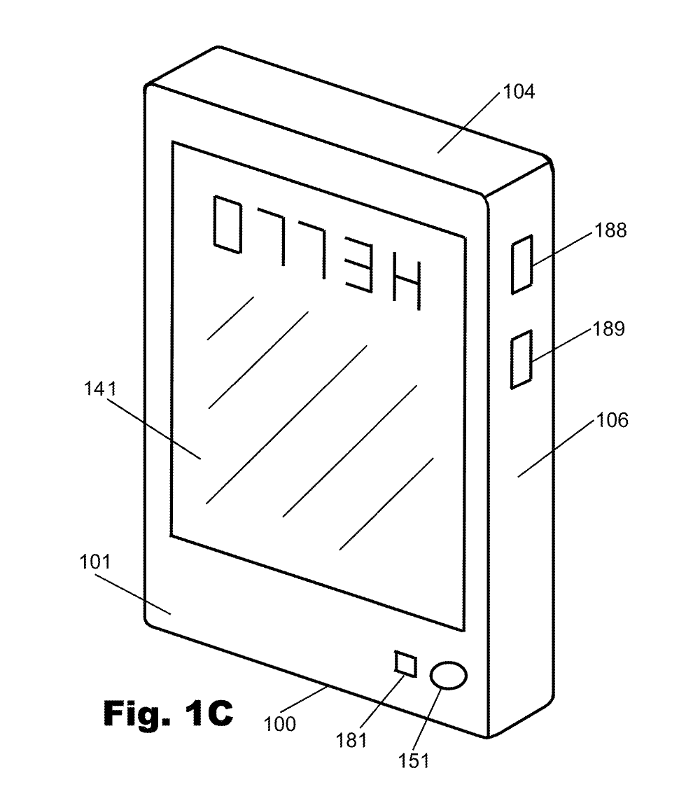

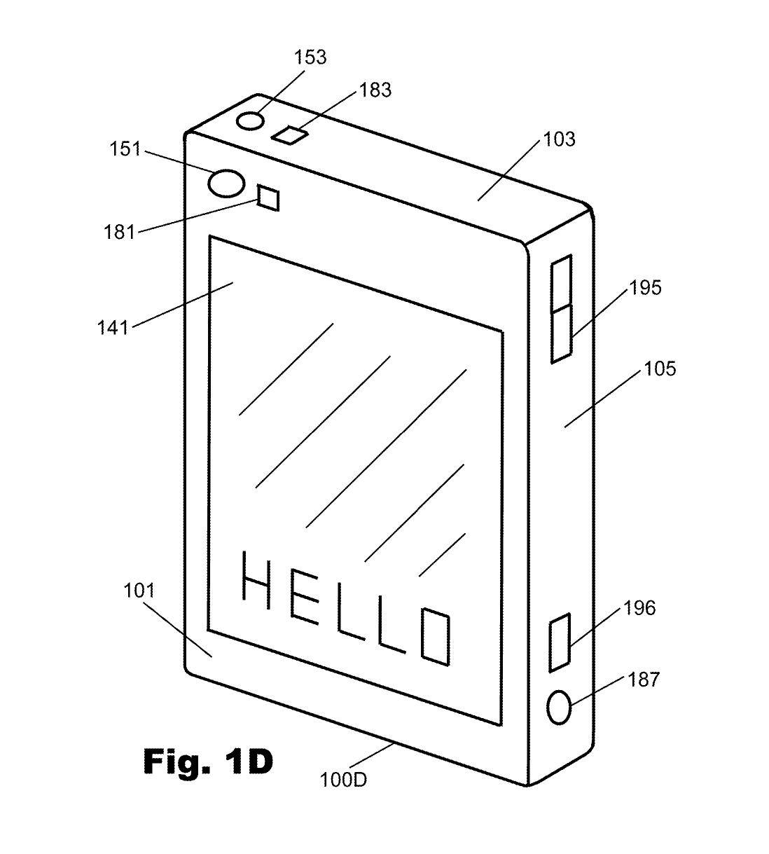

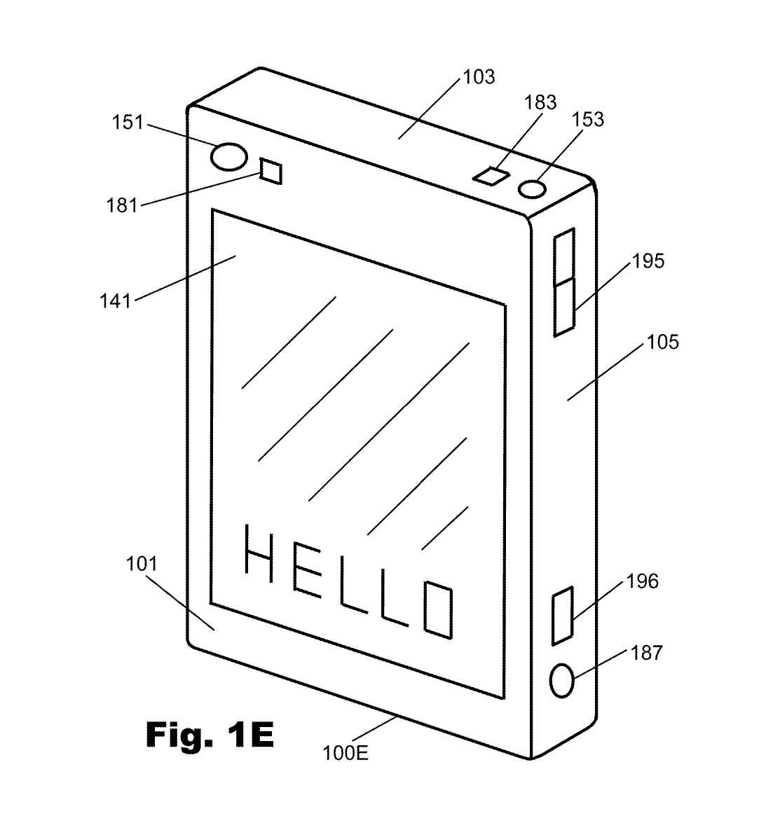

Reference is made to FIGS. 1A, 1B and 1C, which are schematic illustrations of an electronic device 100 in accordance with some demonstrative embodiments of the invention. Electronic device 100 may be, for example, a mobile computing device, a portable or mobile device, a smartphone, a tablet, a mini-tablet, a “phablet” (phone-tablet device), a portable gaming device, a portable audio/video player, or the like.

FIG. 1A shows device 100 from a first perspective, showing particularly its front-side face and its touch-screen; while FIG. 1B shows device 100 from a second perspective, showing particularly its back-side face; while FIG. 1C shows device 100 from a third perspective, in which device 100 stands “upside down” (or, stands “on its head”) and showing its front-side face.

Electronic device 100 may be generally box-shaped, or may be generally a rectangular cuboid, or may be generally a prism, or may have six faces or six panels, or may have six generally-rectangular faces or six generally-rectangular panels. In some embodiments, a face or panel that is rectangular or generally rectangular, may have rounded corners, or may have smooth or curved corners, or may have slanted or diagonal corners; and may be symmetrical or non-symmetrical.

In some embodiments, device 100 may be a rectangular prism or a cuboid having sharp corners or sharp edges or sharp panels. In other embodiments or implementations, device 100 may have rounded or smooth or slanted or non-sharp corners or edges or panels or faces. In some embodiments, for example, device 100 may be an octagonal prism, and a cross-section of device 100 may be an octagon, particularly an octagon formed by taking an elongated rectangle and replacing each 90-degree corner with a small 45-degree slanting diagonal line.

In some embodiments, device 100 may be wedge-shaped, or may have a “bump” or a diagonal bump in its rear side, in order to contain or store or accommodate a battery or a power cell; and the drawings may not necessarily show such possible bump or wedge, or other possible non-flat surface or non-flat region.

Electronic device 100 may have a front-side face 101, which may comprise a screen 141 embedded therein or integrated thereon. Screen 141 may be able to display graphics, texts, images and/or videos; and may optionally be a touch-screen or a multi-touch-screen, able to receive tactile input, user input, input provided by finger gestures, input provided by stylus gestures, or the like. Optionally, front-side face 101 may further include a front-facing camera 151, or may include an aperture or orifice for such front-facing camera 151.

Electronic device 100 may have a rear-side face 102, which may optionally include a rear-side camera 152 or an aperture or orifice for such rear-facing camera 152.

Electronic device 100 may further include a top-side face 103, a bottom-side face 104, a right-side face 105, and a left-side face 106.

Front-side face 101 may be generally parallel to rear-side face 102. Front-side face 101 may be generally perpendicular to faces 103-106.

Rear-side face 102 may be generally parallel to front-side face 101. Rear-side face 102 may be generally perpendicular to faces 103-106.

Top-side face 103 may be generally parallel to bottom-side face 104. Top-side face 103 may be generally perpendicular to front-side face 101, to rear-side face 102, to right-side face 105, and to left-side face 106.

One or more of faces 101-106 may include one or more optional components, for example, a volume button or slider or controller, an earphone socket, a USB or mini-USB or micro-USB port, an HDMI port or mini-HDMI port or micro-HDMI port, or the like. USB stands for Universal Serial Bus. HDMI stands for High-Definition Multimedia Interface. In a demonstrative example, left-side face 106 may include a micro-USB port 188, and a mini-HDMI port 189. In a demonstrative example, right-side panel 105 may include a volume controller 195, a power button 196, and an audio output port 187 (e.g., a female socket able to accommodate a male audio jack, a 3.5 millimeter audio jack, a 2.5 millimeter audio jack, or the like).

Top-side face 103 may include a camera 153 able to capture or acquire images and/or videos; for example, comprising a High-Definition (HD) camera or 720p camera, a Full-HD camera of 1080p camera, a CMOS (Complementary Metal-Oxide-Semiconductor) imager or camera, an Active-Pixel Sensor (APS) imager or camera, a CCD (Charge-Coupled Device) imager or camera, or the like. Camera 153 may be referred to herein, also, as a thin-side camera, a thin-face camera, a thin-panel camera, a top-side camera, a top-panel camera, or a top-face camera.

Camera 153 may be embedded within, or integrated in, or embedded through the top-side face 103; or may sense or acquire or capture images or videos through the top-side face 103.

Camera 153 may be aimed, or may image, acquire or capture a field-of-view, or an area or region or an object, which may be generally perpendicular to the direction that front-side camera 151 is facing or is acquiring or is capturing.

Camera 153 may be aimed, or may image, acquire or capture a field-of-view, or an area or region or an object, which may be generally perpendicular to the direction that rear-side camera 152 is facing or is acquiring or is capturing.

Camera 153 may be aimed, or may image, acquire or capture a field-of-view, or an area or region or an object, which may be: generally parallel to the longest dimension (or the longest edge) of electronic device 100, or generally parallel to the longest dimension (or the longest edge) of front-side face 101, or generally parallel to the longest dimension (or the longest edge) of screen 141.

When utilizing a conventional smartphone having a rear-side camera, a first user Adam may stand 1.5 meters away (or four feet or five feet away) from a second user Bob, and may wish to capture an image of the face of Bob (or, the upper one-half of the body of Bob, or the upper one-third of the body of Bob). Accordingly, Adam may position the smartphone at the eye-level of Adam, approximately 25 centimeters in front of Adam's eyes, perpendicularly to the ground, and generally parallel to the vertically-standing body of Bob (and to the vertically-standing body of Adam himself). This may be uncomfortable; may require Adam to lift the conventional smartphone towards Adam's eye-level; may require positioning the smartphone directly between the eye-level of Adam and the object-of-interest (e.g., the face of Bob), thereby hiding or obscuring from Adam's view at least some of the object that Adam is attempting to photograph. Additionally, this unique positioning of the smartphone makes it immediately apparent to Bob that Adam is attempting to capture an image (or a video) of Bob, which may not necessarily be desired by Adam (e.g., if Adam desires to acquire image(s) or video(s) of the face of Bob without necessarily letting Bob be aware of this). Additionally, holding the conventional smartphone upright and vertical, perpendicularly to the ground, at eye-level, may be uncomfortable for the user Adam, and may require the user Adam to twist his hand that holds the smartphone (e.g., the thumb pointing upwardly towards the sky or the ceiling; the other four fingers wrapped or stretched around the smartphone and curling back towards Adam's body).

In contrast, in accordance with some demonstrative embodiments, a user Carl may utilize electronic device 100 (e.g., a smartphone or a tablet) to capture image(s) or video(s) of a user David, without having to assume the particular position described above. The user Carl may hold the electronic device 100 at the level of Carl's waist or tummy or heart, and not at the level of Carl's eyes or Carl's head or David's face. The user Carl may hold the electronic device at a slanted angel, for example, approximately 30 or 35 or 40 or 45 or 50 or 55 or 60 degrees relative to the ground, “aiming” or directing the top-side camera 153 at an angel towards the desired object-of-interest (e.g., the head of David). In some embodiments, David may not necessarily notice that Carl is attempting to acquire (or is acquiring) images or videos of David, since the electronic device 100 may not be held conspicuously in front of David's face, and may not be positioned conspicuously at the eye-level or the head-level of David and/or Carl. This may optionally allow Carl to acquire images and/or videos of David in a convert or secret manner, without necessarily drawing the attention of David to the imaging process. This may allow, for example, acquisition of a more naturally-looking image or video, or acquisition of an image or video of David (or other person or object) in a more “natural” or non-tampered or non-staged situation, thereby optionally providing more realistic (or “naturally looking”) images or videos, or less “staged” images or videos in which the acquired object may be aware of the imaging process and may act (e.g., intentionally) upon such awareness.

In some embodiments, electronic device 100 may be implemented by using a housing 110 which may enclose therein some or all of the hardware components which may be included in electronic device 100, for example, a processor, a memory unit, a storage unit, a SIM card, or the like. Such housing 110 may be generally box-shaped, or may be a generally rectangular cuboid, or may have one or more rounded or curved or smooth corners. Optionally, housing 110 may include an aperture 111 or other suitable orifice or opening or hole, which may be located at the top-side face of housing 110, and which may allow a camera (e.g., located within the housing 110) to acquire images or videos there-through.

Top-side camera 153 may be associated with, or may be controlled by or operated by, a camera application which may run on the electronic device, and which may allow a user to initiate capturing of image(s) and/or video(s), for example, by pressing an on-screen button, by uttering a speech utterance or other sound which may be recognized (e.g., using a speech recognition module or a speech-to-text module), or by other means of providing user input or user command. In response to such command or input, top-side camera 153 may acquire image(s) and/or video(s), and data representing such acquired image(s) or video(s) may be stored in a local memory unit or a local storage unit, or may be transferred or transmitted (e.g., over a wireless communication link, or over the Internet) to a remote repository, to a remote server, to a remote storage device, to a remote “cloud computing” server, or the like.

In some embodiments, top-side camera 153 may be located at (or near) the center of the top-side face 103; or may be located in the central one-third portion of the top-side face 103.

In some embodiments, top-side camera 153 may be located in the rightmost one-third region of the top-side face 103; or in the rightmost one-quarter region of the top-side face 103.

In some embodiments, top-side camera 153 may be located in the leftmost one-third region of the top-side face 103; or in the leftmost one-quarter region of the top-side face 103.

Optionally, top-side camera 153 may be associated with, or coupled to, an illumination unit 183 which may be located on or at top-panel 103, in proximity to top-side camera 153. Optionally, front-side camera 151 may be associated with, or coupled to, an illumination unit 181, which may be located on or at front-panel 101, in proximity to front-side camera 151. Optionally, back-side camera 152 may be associated with, or coupled to, an illumination unit 182, which may be located on or at back-panel 102, in proximity to back-side camera 152.

Each one of illumination units 181-183 may be or may include, for example, a unit able to produce a flash or artificial white in order to illuminate (or to help illuminate) a scene; and may utilize or may include, for example, xenon flash, LED-based flash, or other illumination technique or illumination means.

Each one of cameras 151-153 may be associated with, or coupled to, or connected to, circuitry and/or wires which may connect to other components of device 100; thereby enabling each one of cameras 151-153, for example, to receive an incoming command to capture an image or a video; to respond to such command by acquiring an image and by transferring image data (e.g., raw or compressed or encoded) to a memory unit or a processor; to acquire video and transfer video data (e.g., raw or compressed or encoded) to a memory unit or a processor; to configure settings of the camera, for example, brightness level, contrast level, special effects (e.g., black-and-white or greyscale effect, polarized effect, negative image effect), illumination settings (e.g., turn illumination unit off; force illumination unit to illuminate; operate the illumination unit automatically if it is determined that ambient illumination does not suffice, or that artificial illumination is required); or the like. Optionally, each one of cameras 151-153 may be able to output data in raw format (e.g., uncompressed, unencoded), or compressed (e.g., using JPEG compression for captured images), or encoded (e.g., using H.264 encoding for captured video).

In some embodiments, optionally, top-panel camera 153 may acquire images and/or videos simultaneously while front-side camera 151 captures images and/or videos, and/or simultaneously while back-side camera 152 captures images and/or videos. This may allow a user, for example, to acquire multiple concurrent images or multiple concurrent videos, of a three-dimensional event or scene. In some embodiments, for example, the user may command the device 100 to simultaneously capture images and/or videos in all three cameras 151-153, or in two out of the three cameras 151-153, thereby capturing a scene or an event from multiple angels. For example, a user may hold the device 100 generally vertically, or generally perpendicularly to the ground, and may stand in an open field on a cloudy or rainy day; the top-side camera 151 may capture an image or a video of a bird flying above the user, or may capture an image or a video of a cloud or a lightning in the sky; and concurrently, the front-side camera 151 may capture an image or a video of the user's face, or of a house that appears in the scene behind the user's body; and concurrently, the back-side camera 152 may capture an image or a video of the opposite side of the scene, for example, a field of flowers or a dog running. This may allow the user to capture multiple concurrent images (or videos) from a single device, the images or videos in opposite directions or in perpendicular directions. Optionally, the device 100 may be configured to allow concurrent one-click operation (e.g., activation and/or deactivation) of all three cameras 151-153, such that a single click or a single user-command may suffice to concurrently activate or concurrently operate all three cameras 151-153, thereby providing a user-friendly and efficient mechanism to capture such multi-perspective images or videos.

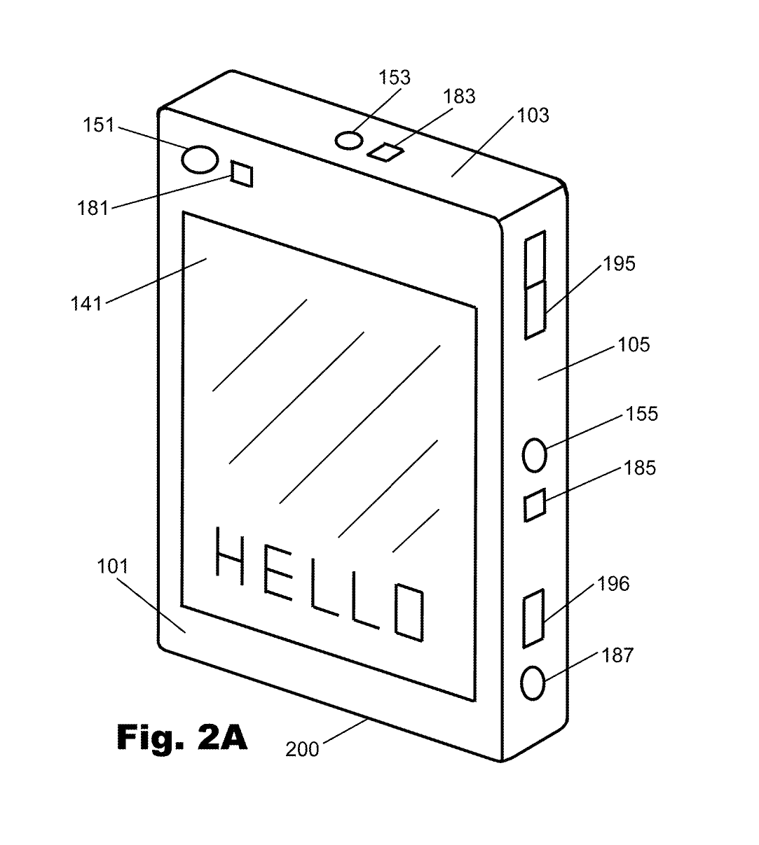

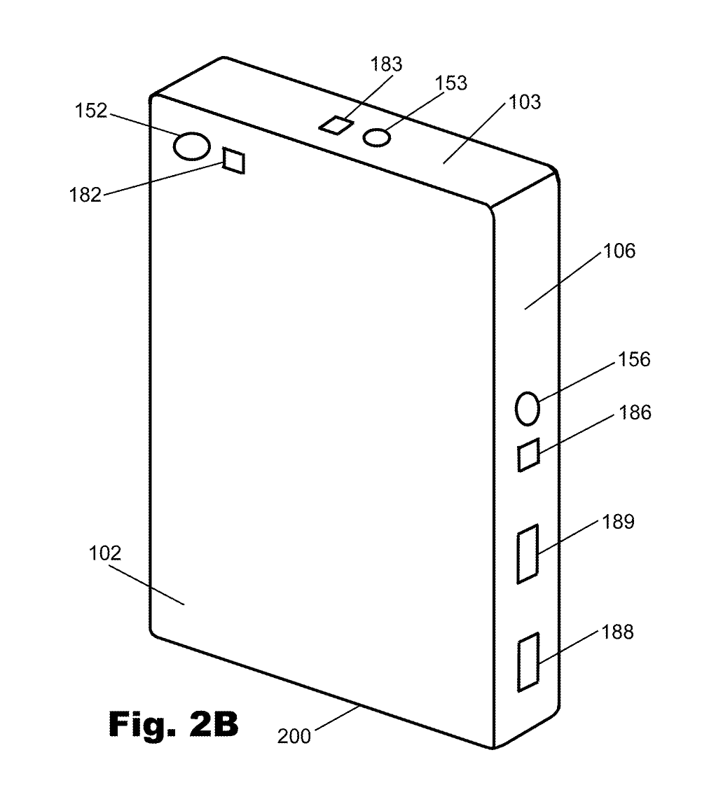

Reference is made to FIGS. 2A, 2B and 2C, which are schematic illustrations of an electronic device 200 in accordance with some demonstrative embodiments of the invention. Electronic device 200 may be generally similar to electronic device 100 of FIGS. 1A, 1B and 1C.

FIG. 2A shows device 200 from a first perspective, showing particularly its front-side face and its touch-screen; while FIG. 2B shows device 200 from a second perspective, showing particularly its back-side face; while FIG. 2C shows device 200 from a third perspective, in which device 200 stands “upside down” (or, stands “on its head”) and showing its front-side face.

Device 200 may have multiple faces, or multiple sides, or multiple panels; for example, device 200 may be generally a rectangular cuboid and may have six faces 101-106. In some embodiments, face 101 may have, or may include, or may house or store, or may have integrated therein, camera 151 and optionally illumination unit 181. Additionally or alternatively, face 102 may have, or may include, or may house or store, or may have integrated therein, camera 152 and optionally illumination unit 182. Additionally or alternatively, face 103 may have, or may include, or may house or store, or may have integrated therein, camera 153 and optionally illumination unit 183. Additionally or alternatively, face 104 may have, or may include, or may house or store, or may have integrated therein, camera 154 and optionally illumination unit 184. Additionally or alternatively, face 105 may have, or may include, or may house or store, or may have integrated therein, camera 155 and optionally illumination unit 185. Additionally or alternatively, face 106 may have, or may include, or may house or store, or may have integrated therein, camera 156 and optionally illumination unit 186.

Accordingly, device 200 may include, for example, one camera; or two cameras facing different directions; or three cameras facing different directions; or four cameras facing different directions; or five cameras facing different directions; or six cameras facing different directions.

In some embodiments, device 200 may have exactly one camera out of the six optional cameras 151-156. In other embodiments, device 200 may have exactly two cameras out of the six optional cameras 151-156. In other embodiments, device 200 may have exactly three cameras out of the six optional cameras 151-156. In other embodiments, device 200 may have exactly four cameras out of the six optional cameras 151-156. In other embodiments, device 200 may have exactly five cameras out of the six optional cameras 151-156. In other embodiments, device 200 may have exactly six cameras (namely, all six cameras) out of the six optional cameras 151-156.

In some embodiments, one or more of the cameras 151-156 of device 200 may enable a user to utilize the camera for covert operations, for secretly capturing images and/or videos, for spying or data collection, or the like. In a demonstrative implementation, for example, device 200 may include camera 155 located in face 105; and camera 155 may face, generally, towards the right side of device 200 and/or its user; thereby allowing the user of device 200 to capture images and/or videos of a person or object or scene located to the right side of the user, without turning the user's body or hand towards that direction, and without turning or tilting or slanting device 200 towards that direction.

In some embodiments, device 100 and/or device 200 may allow a user to capture a panoramic image or panoramic video; or to capture a semi-spherical or a full-spherical scene. Optionally, an image stitching module or a video stitching module may be used in order to stitch together (or otherwise assemble or fuse together) multiple images, or multiple video frames, in order to generate a panoramic image or video, a 180 degrees image or video, a 270 degrees image or video, a 360 degrees image or video, or the like. For example, the stitching module may identify overlapping regions among multiple images or video frames, and may connect or assemble images or video frames by using such overlapping regions as connection region or assembly regions.

In some embodiments, device 100 and/or device 200 may include a camera selector module, allowing a user, for example: to select one or more camera(s) that will capture image(s) and/or video(s) when the user presses or clicks or taps on a “record” button (e.g., an on-screen record button); to select one or more camera(s) that the touch-screen of the device 100 or 200 will show their field-of-view or scene, thereby enabling the user to switch or rotate among multiple cameras in order to view on the touch-screen the view that is seen from each one of such cameras 151-156. In some embodiments, a split-screen module may be included in the device, and may show to the user multiple views from multiple cameras (out of cameras 151-156), as multiple rectangles or multiple squares on the touch screen, or as a picture-in-picture or side-by-side arrangement, thereby enabling concurrent or simultaneous viewing of the scenes that each such camera is capturing (or is about to capture, or is ready to capture).

The term “camera” or “image sensor” or “imager” as used herein may optionally include, in some embodiments, a pair of two cameras (or two image sensors, or two imagers), which may be located on the same face or on the same plane, and may be slightly spaced apart from each other (e.g., approximately 10 or 12 or 15 or 20 or 24 or 30 millimeters apart), able to simultaneously capture images and/or videos, thereby allowing such pair-of-cameras to capture three-dimensional (3D) images or videos, or stereoscopic images or videos, or, to capture images or videos which may then be processed or modified in order to provide to a viewer an experience similar to viewing a 3D image or a 3D video. In some embodiments, each one of (or, any one of) cameras 151, 152, 153, 154, 155 and/or 156 may be implemented as such pair-of-cameras or as dual-adjacent-cameras.

Reference is made again to FIG. 1A, as well as to FIG. 1D and FIG. 1E, which are schematic illustrations of an electronic device in accordance with some demonstrative embodiments of the invention. FIG. 1A shows device 100, in which the top-side camera 153 (and the top-side illumination unit 183) are located at the center of top-side panel 103, or, are located within the central one-third region of top-side panel 103. FIG. 1D shows a similar device 100D, which may be generally similar to device 100; but in device 100D, the top-side camera 153 (and the top-side illumination unit 183) are located at the leftmost region of top-side panel 103, or, are located within the leftmost one-third region of top-side panel 103. FIG. 1E shows a similar device 100E, which may be generally similar to device 100; but in device 100E, the top-side camera 153 (and the top-side illumination unit 183) are located at the rightmost region of top-side panel 103, or, are located within the rightmost one-third region of top-side panel 103. Other suitable locations or positions may be used, for top-side camera 153, or similarly, for any of the other optional cameras 151-156 which may be included in such device 100, 100D or 100E, or in device 200.

In some embodiments, a front-side panel (or a front-side face) of the device (e.g., device 100, device 200, or the like) may comprise a screen or a touch-screen. Optionally, in some embodiments, such screen or touch-screen, and such front-side panel, may be a unified component such that the screen or the touch-screen occupies most, or all, or substantially all, of the front-side panel; or, such that the screen or touch-screen acts also as a front-side panel or as part of the housing of the device. Optionally, in some embodiments, substantially all of the front-side panel or face, may actually be the screen or touch-screen.

In some embodiments, device 100 and/or device 200 may include some or all of the following components: a processor (e.g., a general purpose processor, a specific purpose processor, a controller, a Central Processing Unit (CPU), circuitry, an Integrated Circuit (IC), a logic component, a single-core or multiple-core processor, or the like); a memory unit (e.g., phone memory; Secure Digital (SD) card; SIM card; Flash memory; volatile memory; non-volatile memory; RAM; ROM; or the like); a storage unit (e.g., a Flash storage unit, a miniature hard disk, a SIM card, non-volatile storage); a wireless transceiver (e.g., wireless transmitter and/or wireless receiver, a cellular transceiver, a 2G transceiver, a 3G transceiver, a 4G transceiver, a 4G LTE transceiver, a Wi-Fi transceiver, a Wi-Max transceiver, a 3GPP transceiver, an IEEE 802.11 transceiver, an IEEE 802.16 transceiver, or the like); an antenna (e.g., an internal antenna, an external antenna, an internal/external antenna, an omni-directional antenna, a monopole antenna, a dipole antenna, an end fed antenna, a circularly polarized antenna, a micro-strip antenna, a diversity antenna, or the like); a display unit, (e.g., a screen, a monitor, a touch-screen, a multi-touch screen, a screen able to present text and/or graphics and/or images and/or photographs and/or videos); an input unit, (e.g., a physical keyboard, a physical keypad, an on-screen keyboard, an on-screen keypad, a mini joystick, a touch-pad, a touch-screen, a multi-touch screen, a tactile interface, a stylus, or the like); a microphone able to receive and/or sense and/or capture audio signals spoken or uttered by a user; one or more speaker(s) able to produce audio and/or sound; a power source (e.g., a battery, a rechargeable battery, a replaceable battery, or the like); a graphic processor (e.g., a Graphic Processing Unit (GPU), a graphics accelerator, or the like); an Operating System (OS) (e.g., Apple iOS, Android, a Microsoft OS or a Windows OS, Symbian, a Linux or Unix OS, a Blackberry OS, or the like); one or more physical buttons, or a single physical button (e.g., similar to the round physical button of an Apple iPhone); a USB port (or mini-USB port or micro-USB port); an audio socket for connecting earphones or headphones and/or for providing audio output therethrough; an HDMI port (or mini-HDMI port or micro-HDMI port); one or more applications or “apps”; one or more light sensor(s) or light meters or light measuring components, which may be independent from other components, or may be associated with or integrated with one or more camera(s) or one or more illumination unit(s); one or more illumination unit(s) or light-producing unit(s) or “flash” illumination components, which may be independent from other components, or may be associated with or integrated with one or more camera(s); a Global Positioning System (GPS) receiver or unit, or other location-determining or location-estimating component able to determine location or geographical or geo-spatial location (e.g., based on having a line-of-sight with multiple GPS satellites, or by using other location-estimating or location-determining methods); one or more accelerometer(s) and/or gyroscope(s), or motion sensors, or other suitable components able to determine and/or detect and/or measure and/or estimate, for example, acceleration or deceleration or change-of-velocity of proper acceleration or four-acceleration, optionally in conjunction with an Inertial Navigation System (INS), or in conjunction with a system or sub-system able to substantially continuously calculate (e.g., via dead reckoning or deduced reckoning or DR) the position and/or orientation and/or velocity (e.g., direction and speed of movement) of the device without the need for an external reference or without relying on any object or satellite or item external to the device; and/or other suitable modules or components. In some embodiments, components and/or modules may be enclosed in, or may be held in, a housing or enclosure or container.

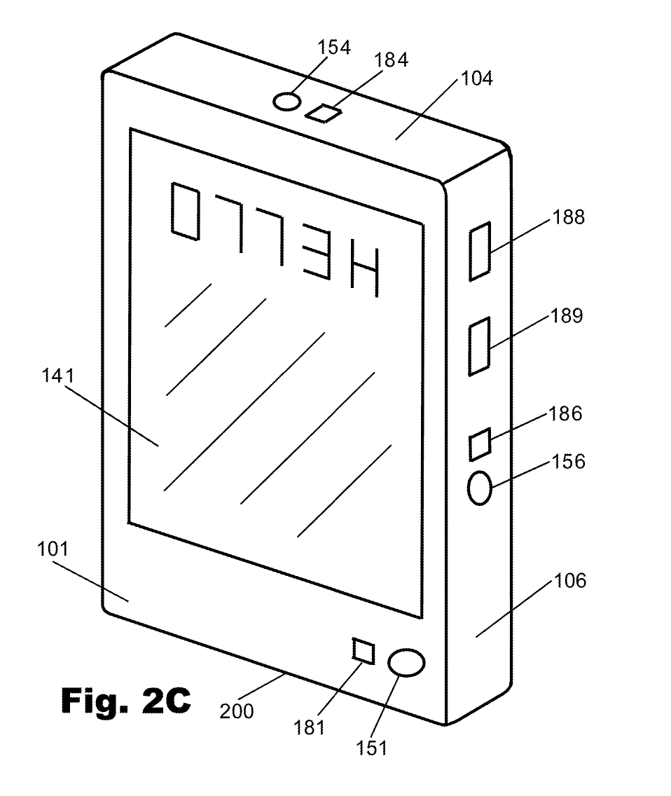

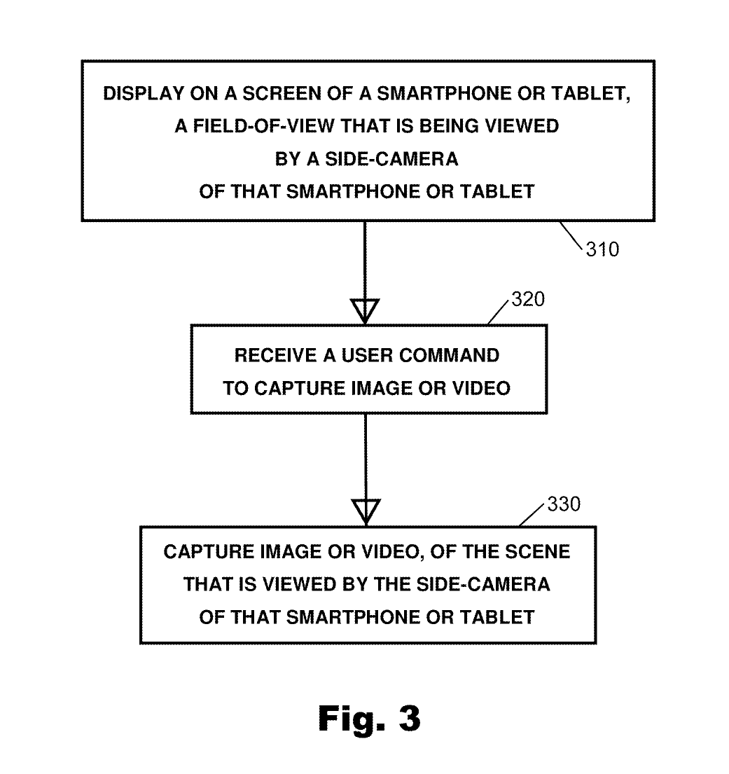

Reference is made to FIG. 3, which is a flow-chart of a method in accordance with some demonstrative embodiments of the present invention. The method may be implemented, for example, using a smartphone or a tablet or other electronic device as described herein, or using other suitable machine or computerized device.

The method may include, for example, displaying on a screen of a smartphone or tablet, a field-of-view that is being viewed by a side-camera of such smartphone or tablet (block 310); for example, displaying a scene that is viewed by top-side camera 153.

The method may further include, for example, receiving a user command to capture an image or a video (block 320); for example, by receiving a user tap or click or press, on the touch-screen or on a physical button of the smartphone or tablet.

The method may further include, for example, in response to the user command, capturing an image or a video, of the scene that is viewed by the side-camera of that smartphone or tablet (block 330); for example, by the top-side camera 153.

The method may be applied to other side-camera(s) of the smartphone or tablet.

Optionally, the method may include, for example, displaying concurrently the scene viewed by the side-camera, together with (e.g., side by side, or picture-in-picture, or in a windowed display) the scene(s) of one or more other camera(s) of that smartphone or tablet.

Optionally, the method may include, for example, switching between or among the views of multiple cameras of the electronic device, wherein at least one of the cameras is a side-camera.

Other suitable operations or sets of operations may be used.

In some embodiments, optionally, images and/or video captured by side camera(s) of the smartphone or tablet (or other device 100 or 200, or the like), may be broadcast using wireless link(s) and/or wired link(s), for example, to a remote location, to a remote receiver, or as a “web-camera”; as a generally continuous stream of images or frames or video; as part of a web-cam interaction; as part of a video conference or a video call; or the like.

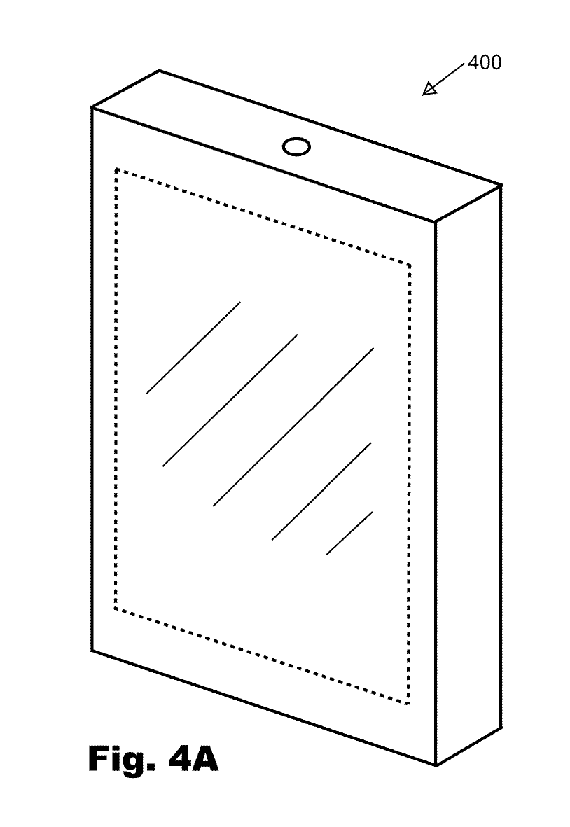

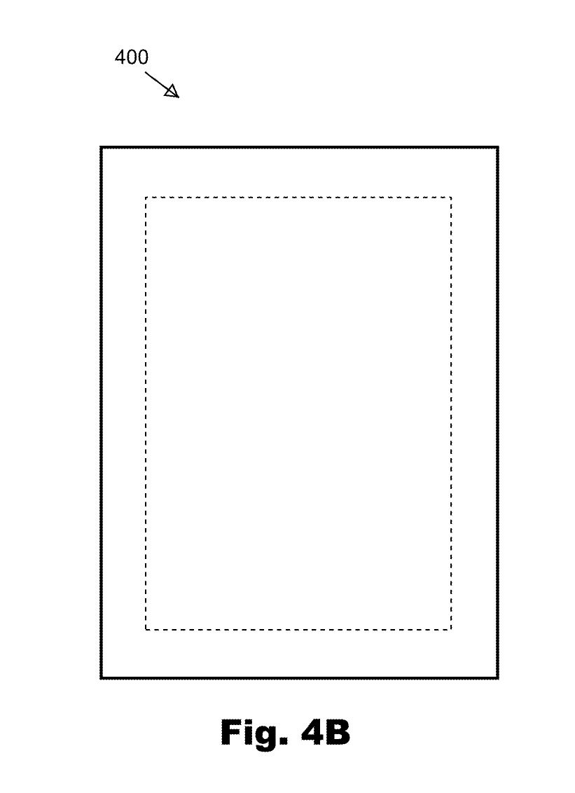

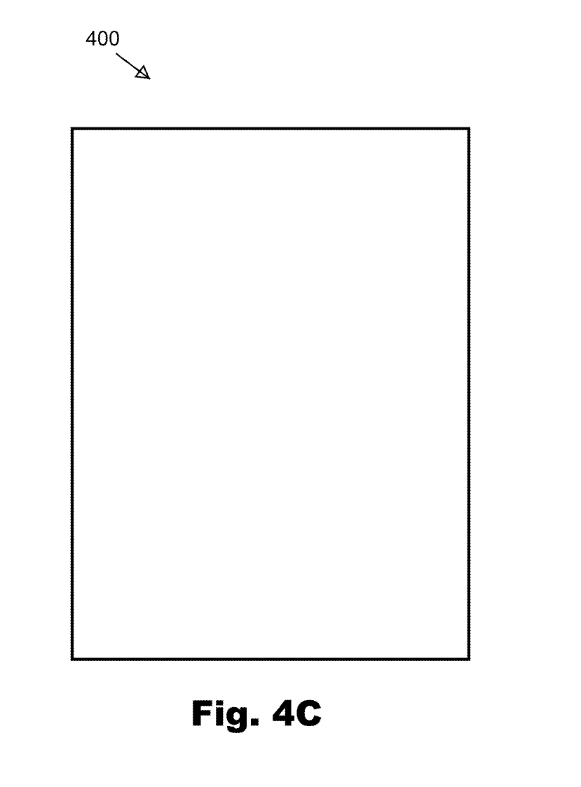

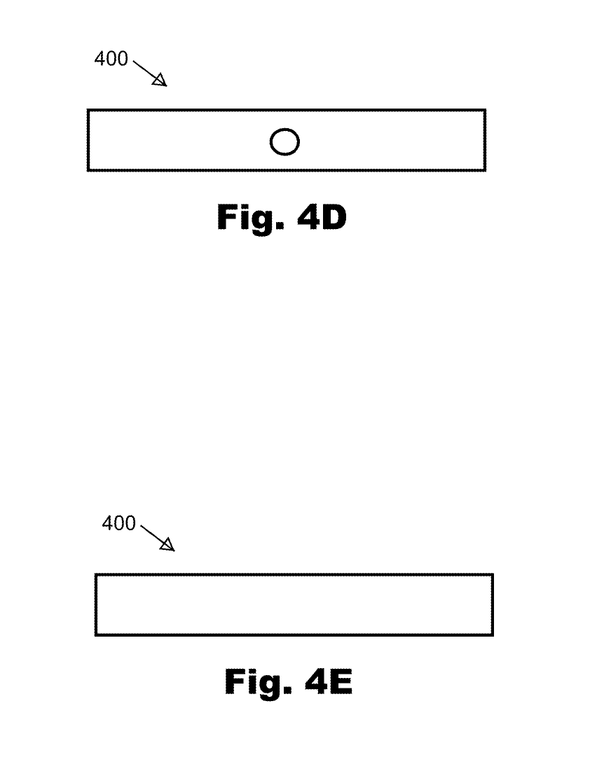

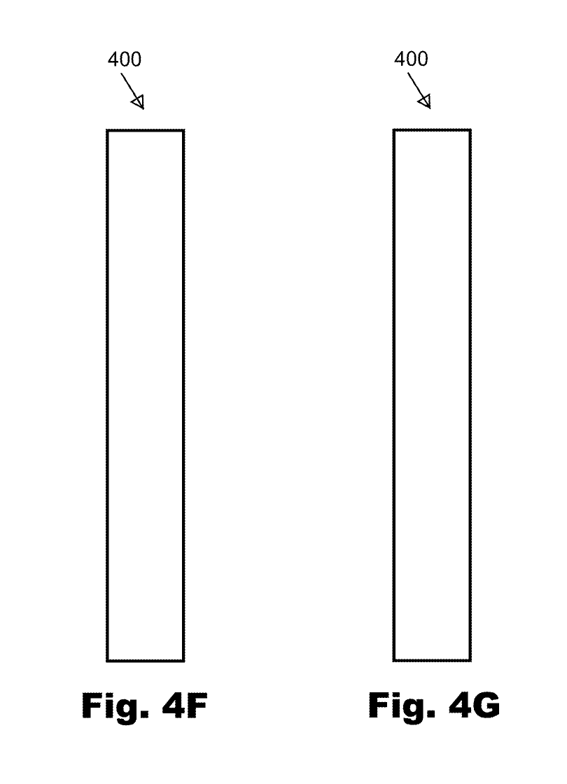

Reference is made to FIGS. 4A-4G, which are multiple views of a device 400 in accordance with some embodiments of the invention. Device 400 may be a smartphone, a tablet, or other portable electronic device. Device 400 may be generally similar to device 100 and/or device 200; and in order to show clearly one of the novel aspects of the present invention, device 400 is shown as having the top-side camera, located at the center of the top-side panel of device 400.

For demonstrative purposes, device 400 is shown as having sharp corners or sharp edges; however, in some embodiments of the present invention, device 400 may have rounded corners, rounded edges, curved corners, curved edges, smooth or non-sharp corners, smooth or non-sharp edges, radial corners, radial edges, slanted corners, slanted edges, or other suitable shapes, for example, in order to enable a user to comfortably hold or grip or user the device.

Particularly, FIG. 4A shows a perspective view of device 400; FIG. 4B shows a front view of device 400; FIG. 4C shows a rear view of device 400; FIG. 4D shows a top view of device 400, with the circle indicating the location of the top-side camera; FIG. 4E shows a bottom view of device 400; FIG. 4F shows a right-side view of device 400; FIG. 4G shows a left-side view of device 400. In order to not obscure one of the novel aspects of the present invention, device 400 does not show conventional components such as, for example, a power button, an audio socket, a USB port, an HDMI port, a volume button, or the like; and does not show other camera(s) and/or illumination unit(s) which may optionally be included; however, such components may optionally be included in device 400.

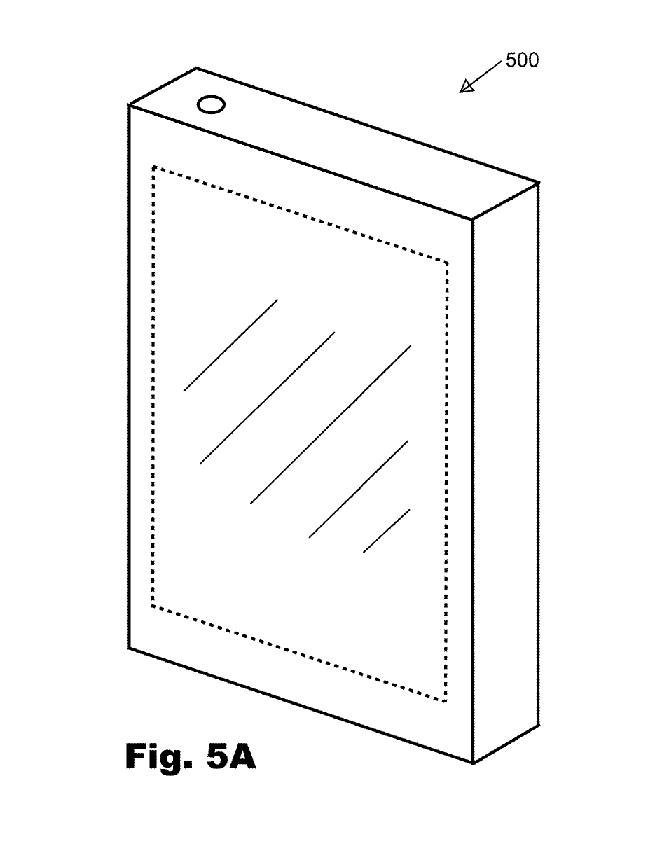

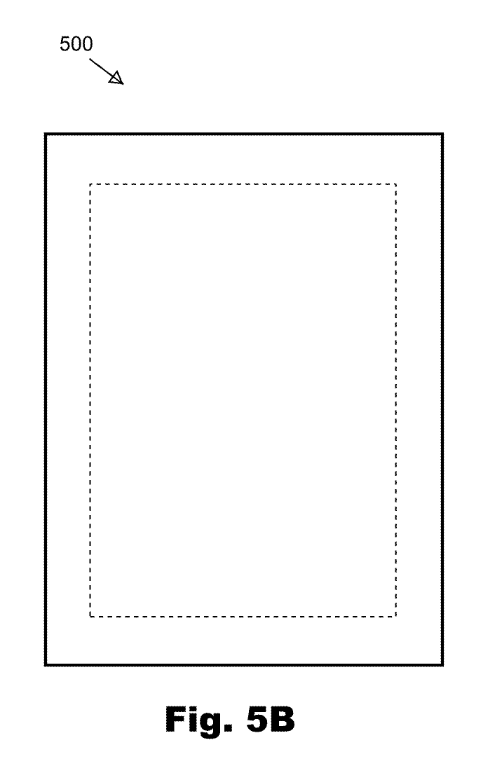

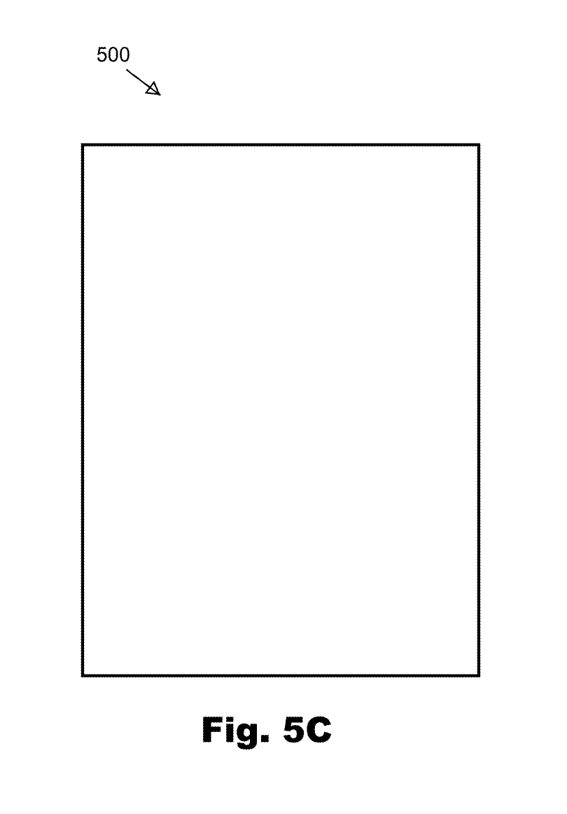

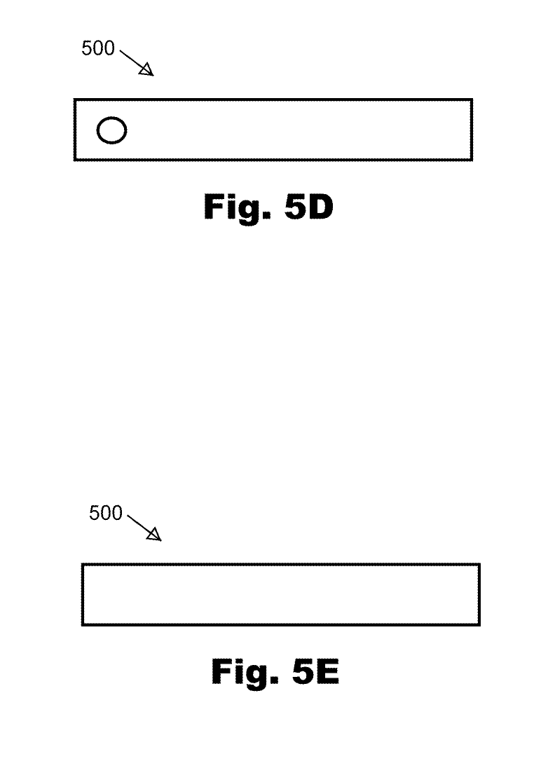

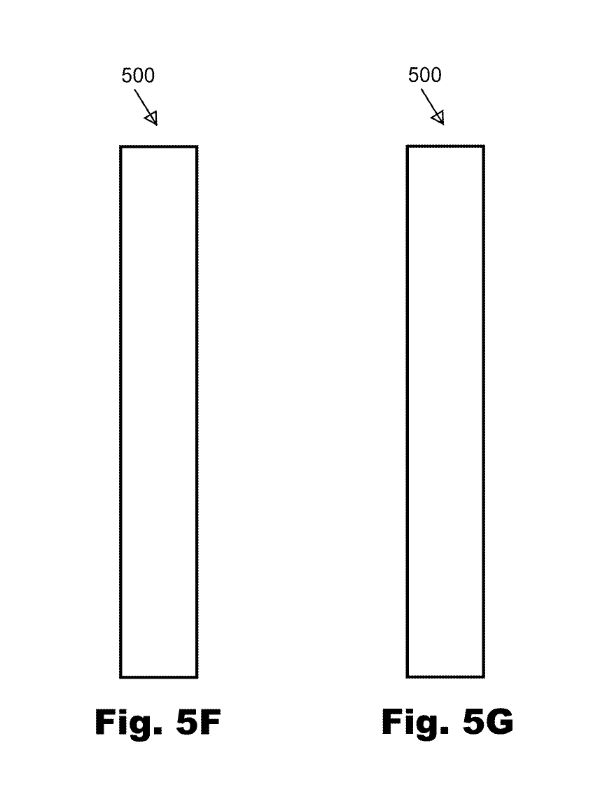

Reference is made to FIGS. 5A-5G, which are multiple views of a device 500 in accordance with some embodiments of the invention. Device 500 may be a smartphone, a tablet, or other portable electronic device. Device 500 may be generally similar to device 100 and/or device 200; and in order to show clearly one of the novel aspects of the present invention, device 500 is shown as having the top-side camera, located at the leftmost region of the top-side panel of device 500.

For demonstrative purposes, device 500 is shown as having sharp corners or sharp edges; however, in some embodiments of the present invention, device 500 may have rounded corners, rounded edges, curved corners, curved edges, smooth or non-sharp corners, smooth or non-sharp edges, radial corners, radial edges, slanted corners, slanted edges, or other suitable shapes, for example, in order to enable a user to comfortably hold or grip or user the device.

Particularly, FIG. 5A shows a perspective view of device 500; FIG. 5B shows a front view of device 500; FIG. 5C shows a rear view of device 500; FIG. 5D shows a top view of device 500, with the circle indicating the location of the top-side camera; FIG. 5E shows a bottom view of device 500; FIG. 5F shows a right-side view of device 500; FIG. 5G shows a left-side view of device 500. In order to not obscure one of the novel aspects of the present invention, device 500 does not show conventional components such as, for example, a power button, an audio socket, a USB port, an HDMI port, a volume button, or the like; and does not show other camera(s) and/or illumination unit(s) which may optionally be included; however, such components may optionally be included in device 500.

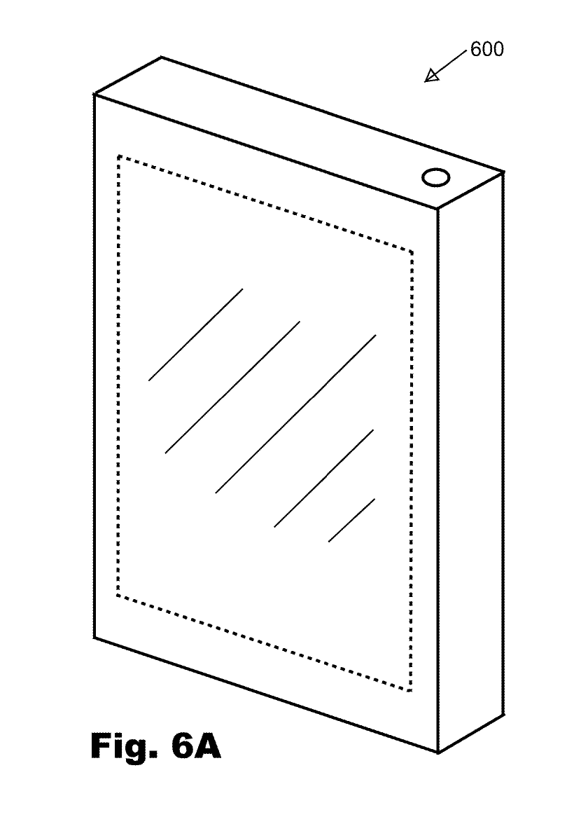

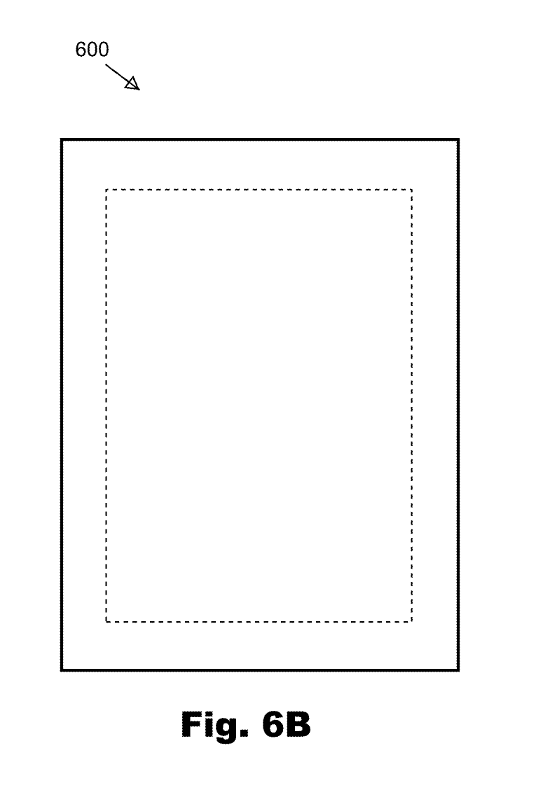

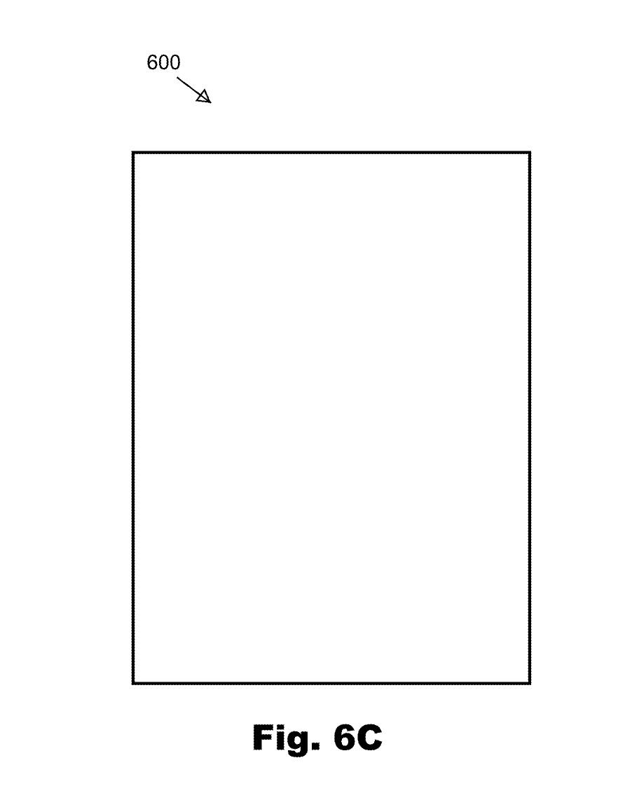

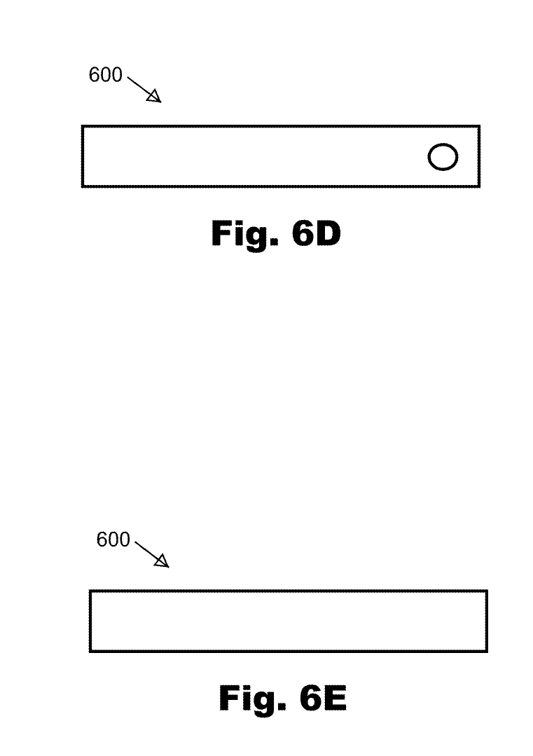

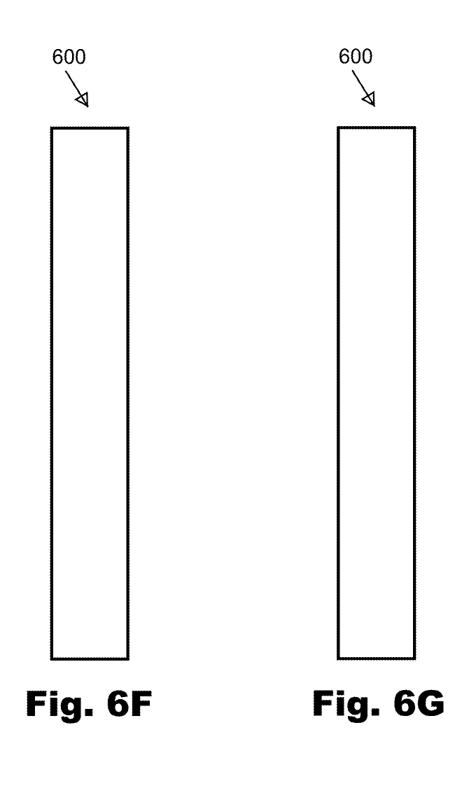

Reference is made to FIGS. 6A-6G, which are multiple views of a device 600 in accordance with some embodiments of the invention. Device 600 may be a smartphone, a tablet, or other portable electronic device. Device 600 may be generally similar to device 100 and/or device 200; and in order to show clearly one of the novel aspects of the present invention, device 600 is shown as having the top-side camera, located at the rightmost region of the top-side panel of device 600.

For demonstrative purposes, device 600 is shown as having sharp corners or sharp edges; however, in some embodiments of the present invention, device 600 may have rounded corners, rounded edges, curved corners, curved edges, smooth or non-sharp corners, smooth or non-sharp edges, radial corners, radial edges, slanted corners, slanted edges, or other suitable shapes, for example, in order to enable a user to comfortably hold or grip or user the device

Particularly, FIG. 6A shows a perspective view of device 600; FIG. 6B shows a front view of device 600; FIG. 6C shows a rear view of device 600; FIG. 6D shows a top view of device 600, with the circle indicating the location of the top-side camera; FIG. 6E shows a bottom view of device 600; FIG. 6F shows a right-side view of device 600; FIG. 6G shows a left-side view of device 600. In order to not obscure one of the novel aspects of the present invention, device 600 does not show conventional components such as, for example, a power button, an audio socket, a USB port, an HDMI port, a volume button, or the like; and does not show other camera(s) and/or illumination unit(s) which may optionally be included; however, such components may optionally be included in device 600.

Optionally, the device (e.g., device 100, device 200, or the like) may include (e.g., internally, or on the surface of the device), one or more means or mechanisms which may assist in mounting, placing, positioning and/or securing each one of the camera(s) 151-156 in its particular place, and/or to ensure that such camera(s) 151-156 is facing towards the desired field-of-view or angle. Some implementations may use, for example, secure holding or mounting which may utilize glue, bonding, screws, mounting by pressure, male-female connection mechanism, and/or other suitable means.

In some embodiments, any one of the circles or ovals that appear in any of the drawings (including, but not limited to, items 151-156), may represent a camera, or an imager, or an image sensor; and/or may represent a lens or a light-sensing or a light-capturing component of a camera; and/or may optionally represent an illumination unit associated with a camera. In some embodiments, any one of the circles or ovals that appear in any of the drawings (including, but not limited to, items 151-156), may represent a hole or an aperture or an orifice, in a housing or in a frame or in an enclosure, of the device (e.g., the smartphone, the tablet, or the like), in which such camera (and optionally an illumination unit) may be embedded and/or integrated (e.g., as an integral part of such housing or frame or enclosure). In some embodiments, any one of the circles or ovals that appear in any of the drawings (including, but not limited to, items 151-156), may represent a hole or an aperture or an orifice, in a housing or in a frame or in an enclosure, of the device (e.g., the smartphone, the tablet, or the like), behind which a camera may be located, and through which such camera may acquire images and/or videos. Accordingly, any such circle or oval may represent a camera, or a lens, or an illumination unit, or an aperture in a housing through which a camera may capture images and/or videos, or a combination of any of the above.

In some embodiments, a smartphone may comprise: a wireless transceiver to send and receive wireless communication signals; a processor to execute code; a front-side panel comprising a touch-screen; a back-side panel, located opposite to and generally parallel to said front-side panel, the back-side panel comprising a back-side camera; a side panel, being generally perpendicular to said front-side panel and being generally perpendicular to said back-side panel, the side panel comprising a side camera.

In some embodiments, the front-side panel comprises a front-side camera is aimed towards a first direction; and the back-side camera is aimed towards a second direction which is generally opposite to said first direction; and the side camera is aimed towards a third direction, wherein the third direction is generally perpendicular to said first direction, and wherein the third direction is generally perpendicular to said second direction.

In some embodiments, when the smartphone is held such that the front-side panel is generally perpendicular to a ground, the side camera is aimed at a direction that is generally vertical or generally perpendicular to the ground.

In some embodiments, when the smartphone is held such that the front-side panel is generally perpendicular to a ground, the side camera is aimed at a direction that is generally horizontal or generally parallel to the ground.

In some embodiments, said side camera is located in said side panel which has a smallest surface out of all surfaces of all panels of said smartphone.

In some embodiments, the side camera is located within a central one-third region of said side panel.

In some embodiments, the side camera is located within a rightmost one-third region of said side panel.

In some embodiments, the side camera is located within a leftmost one-third region of said side panel.

In some embodiments, a tablet may comprise: a wireless transceiver to send and receive wireless communication signals; a processor to execute code; a front-side panel comprising a touch-screen; a back-side panel, located opposite to and generally parallel to said front-side panel, the back-side panel comprising a back-side camera; a side panel, being generally perpendicular to said front-side panel and being generally perpendicular to said back-side panel, the side panel comprising a side camera.

In some embodiments, the front-side panel comprises a front-side camera aimed towards a first direction; the back-side camera is aimed towards a second direction which is generally opposite to said first direction; the side camera is aimed towards a third direction; the third direction is generally perpendicular to said first direction, and wherein the third direction is generally perpendicular to said second direction.

In some embodiments, when the tablet is held such that the front-side panel is generally perpendicular to a ground, the side camera is aimed at a direction that is generally vertical or generally perpendicular to the ground.

In some embodiments, wherein, when the tablet is held such that the front-side panel is generally perpendicular to a ground, the side camera is aimed at a direction that is generally horizontal or is generally parallel to the ground.

In some embodiments, said side camera is located in said side panel which has a smallest surface out of all surfaces of all panels of said tablet.

In some embodiments, the side camera is located within a central one-third region of said side panel.

In some embodiments, the side camera is located within a rightmost one-third region of said side panel.

In some embodiments, the side camera is located within a leftmost one-third region of said side panel.

In some embodiments, the side camera (of the smartphone or tablet) is not a front-facing camera and is not a rear-facing camera.

In some embodiments, the side camera (of the smartphone or tablet) is a camera other than a front-facing camera and other than a rear-facing camera.

In some embodiments, the side camera (of the smartphone or tablet) is facing a direction (or is directed towards an imaging direction) which is other than the front and the back of the camera.

In some embodiments, a smartphone (or tablet) may comprise: a wireless transceiver to send and receive wireless communication signals; a processor to execute code; and a housing to enclose at least said processor and said wireless transceiver. The housing may comprise: a front-side panel comprising a touch-screen; a back-side panel, located opposite to said front-side panel; a right-side panel; a left-side panel, located opposite to said right-side panel; a bottom-side panel; and a top-side panel having an aperture for a top-side camera.

In some embodiments, the smartphone (or tablet) further comprises said top-side camera; wherein said top-side camera is to capture an image through said aperture in said top-side panel of said housing.

In some embodiments, said front-side panel comprises a back-side aperture for a back-side camera; and the smartphone further comprises said back-side camera; and said back-side camera is to capture an image through said back-side aperture in said back-side panel of said housing.

In some embodiments, said front-side panel comprises a front-side aperture for a front-side camera; and the smartphone further comprises said front-side camera; and said front-side camera is to capture an image through said front-side aperture in said front-side panel of said housing.

Some embodiments may include a housing or enclosure or box, structured to accommodate one or more camera(s) 151-156, by having therein, in one or more side-panels or side-faces thereof, suitable apertures or orifices or holes to allow such camera(s) to capture images and/or videos.

Some embodiments may include a protective case for a smartphone or tablet (or for other suitable portable electronic device); the protective case being flexible or rigid or semi-flexible or semi-rigid or rigid-flexible, or having elastic properties, or being able to partially wrap around the electronic device to protect it from impact or scratches. The protective case may have, in one or more side-panels or side-faces thereof, suitable apertures or orifices or holes to allow the side camera(s) to capture images and/or videos.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the claims are intended to cover all such modifications, substitutions, changes, and equivalents.

1-16. (canceled)

17. A smartphone comprising:
a wireless transceiver to send and receive wireless communication signals;
a processor to execute code;
a housing to enclose at least said processor and said wireless transceiver,
wherein the housing comprises:
a front-side panel comprising a touch-screen;
a back-side panel, located opposite to said front-side panel;
a right-side panel;
a left-side panel, located opposite to said right-side panel;
a bottom-side panel; and
a top-side panel having an aperture for a top-side camera,
wherein the top-side panel having the aperture for the top-side camera is fixedly attached to, and is non-detachable from, said front-side panel which comprises said touch-screen.

18. The smartphone of claim 17, further comprising said top-side camera, wherein said top-side camera is to capture an image through said aperture in said top-side panel of said housing, wherein said top-side camera is securely held and integrated in said top-side panel and is non-detachable from said top-side panel and from the smartphone.

19. (canceled)

20. (canceled)

21. The smartphone of claim 17, wherein said aperture for the top-side camera is located within a central one-third region of said top-side panel.

22. The smartphone of claim 17, wherein said aperture for the top-side camera is located within a rightmost one-third region of said top-side panel.

23. The smartphone of claim 17, wherein said aperture for the top-side camera is located within a leftmost one-third region of said top-side panel.

24. A tablet comprising:
a wireless transceiver to send and receive wireless communication signals;
a processor to execute code;
a housing to enclose at least said processor and said wireless transceiver,
wherein the housing comprises:
a front-side panel comprising a touch-screen;
a back-side panel, located opposite to said front-side panel;
a right-side panel;
a left-side panel, located opposite to said right-side panel;
a bottom-side panel; and
a top-side panel having an aperture for a top-side camera,
wherein the top-side panel having the aperture for the top-side camera is fixedly attached to, and is non-detachable from, said front-side panel which comprises said touch-screen.

25. The tablet of claim 24, further comprising said top-side camera, wherein said top-side camera is to capture an image through said aperture in said top-side panel of said housing, wherein said top-side camera is securely held and integrated in said top-side panel and is non-detachable from said top-side panel and from the tablet.

26. The tablet of claim 24, wherein said aperture for the top-side camera is located within a central one-third region of said top-side panel.

27. The tablet of claim 24, wherein said aperture for the top-side camera is located within a rightmost one-third region of said top-side panel.

28. The tablet of claim 24, wherein said aperture for the top-side camera is located within a leftmost one-third region of said top-side panel.
